(19) United States
(12) Patent Application Publication
(10) Pub. No.: US 2007/0149084 A1
(43) Pub. Date: Jun. 28, 2007

(54) Natural fiber as core material in composite sandwich structure

(75) Inventors: David Denis Rouison, Brampton (CA); Lassi M. Ojanen, Richmond Hill (CA)

Correspondence Address: WARN, HOFFMANN, MILLER & LALONE, .P.C, PO BOX 70098, ROCHESTER HILLS, MI, 48307, US

(73) Assignee: Magna International Inc., Aurora (CA)

(21) Appl. No.: 11/316,565

(22) Filed: Dec. 22, 2005

(51) Int. Cl. D04H 3/10; D04H 5/02; B32B 5/02; D04H 1/08; D04H 1/46; G11B 5/706

(52) U.S. Cl. 442/405; 442/152; 428/844.5; 442/321

(57) ABSTRACT

A core component includes a natural fiber portion and a binder portion. The natural fiber portion and the binder portion are combined together, either partially or fully, so as to form a substantially homogenous material. Natural fibers can include: (1) bast fibers such as hemp, flax, kenaf, ramie, jute, and/or the like; (2) leaf fibers such as henequen, abaca, and/or the like; and (3) seed fibers such as cotton and/or the like. The core component can be used in conjunction with a composite structure, e.g., after formation of the core component, a reinforcing material (e.g., glass fibers, carbon fibers, aramid fibers and/or the like) can be placed on either side of the core component and injected with a resin material to form the composite structure. The resin material can be comprised of any number of polymeric materials, such as but not limited to thermoplastics, thermosets, and/or the like.

### FIELD OF THE INVENTION

The present invention relates generally to composite structures, and more particularly to composite sandwich structures employing natural fibers as the core material.

### BACKGROUND OF THE INVENTION

Currently, most core materials for composite sandwich structures are comprised of polymeric foams such as polyvinyl chloride (PVC), polystyrene (PS), polyurethane (PU), acrylics, polyether imide (PEI), styrene-acrylonitrile (SAN), and/or honeycomb materials and wood, such as balsa or cedar. Some important properties of a core material are its shear strength, its stiffness, and its ability to tolerate a compressive load without premature failure.

Core materials are typically used in composite sandwich structures to improve the stiffness of the part or component formed therefrom. For example, polymeric foams are usually formed to the shape of the part in a mold in a process typically several minutes long. Although honeycomb materials provide better strength/weight properties, they also require higher end processing equipment and therefore higher cost. Additionally, other types of materials do not have the ability to be formed easily.

A few problems associated with the use of these materials for core applications include: (1) the forming process lengthens the cycle time for the production of a part component; (2) proper chemical bonding of the core to the skins on the composite sandwich structure is difficult to achieve; and (3) most conventional core materials are not recyclable.

Accordingly, there exists a need for new and improved composite sandwich structures that include core components that are comprised of relatively strong, low cost materials that can be easily, quickly and inexpensively formed.

### SUMMARY OF THE INVENTION

It is an object of the present invention to provide new and improved composite sandwich structures.

It is another object of the present invention to provide new and improved composite sandwich structures that include core components that are comprised of natural fibers.

It is still another object of the present invention to provide new and improved composite sandwich structures that include core components that are comprised of natural fibers and polymeric binders.

In accordance with the general teachings of the present invention, there is provided a formable natural fiber material that can be used as a core component in sandwich composite structures. In accordance with one aspect of the present invention, this material will provide a recyclable, light weight and low cost composite structure. In accordance with another aspect of the present invention, this material can be comprised of natural fibers and a polymeric binder, which will result in a fast forming step. The advantages of this material, with respect to conventional foam cores include, without limitation: (1) shorter forming cycles; (2) enhanced mechanical properties; (3) lower cost; (4) recyclable; and (5) renewable raw material resource.

In accordance with a first embodiment of the present invention, a composite sandwich structure is provided, comprising: (1) a core component is provided for use in connection with a composite structure, comprising: (1) a natural fiber portion; and (2) a polymeric binder portion substantially infiltrating said natural fiber portion.

In accordance with a second embodiment of the present invention, a composite structure is provided, comprising: (1) a core component, comprising: (a) a natural fiber portion; and (b) a polymeric binder portion substantially infiltrating said natural fiber portion; and (2) a skin layer disposed on a surface of said core component.

In accordance with a third embodiment of the present invention, a method is provided for forming a core component for use in connection with a composite structure, comprising: (1) providing a natural fiber portion, wherein the natural fiber portion is a material selected from the group consisting of bast fibers, leaf fibers, seed fibers, and combinations thereof, wherein the bast fibers is a material selected from the group consisting of hemp, flax, kenaf, ramie, jute, and combinations thereof, wherein the leaf fibers is a material selected from the group consisting of henequen, abaca, and combinations thereof, and wherein the seed fibers is comprised of cotton seed fibers; (2) providing a polymeric binder portion, wherein the polymeric binder portion is comprised of a material selected from the group consisting of polyolefins, polyurethanes, polyesters, epoxies, acrylics, and combinations thereof; and (3) substantially infiltrating said natural fiber portion with said polymeric binder portion.

### BRIEF DESCRIPTION OF THE DRAWINGS

The present invention will become more fully understood from the detailed description and the accompanying drawings, wherein:

FIG. 1 illustrates a sectional view of a core component, in accordance with one embodiment of the present invention;

FIG. 2 illustrates a sectional view of an alternative core component, in accordance with a first alternative embodiment of the present invention; and

FIG. 3 illustrates a sectional view of a composite structure, in accordance with a second alternative embodiment of the present invention.

### DETAILED DESCRIPTION OF THE PREFERRED EMBODIMENTS

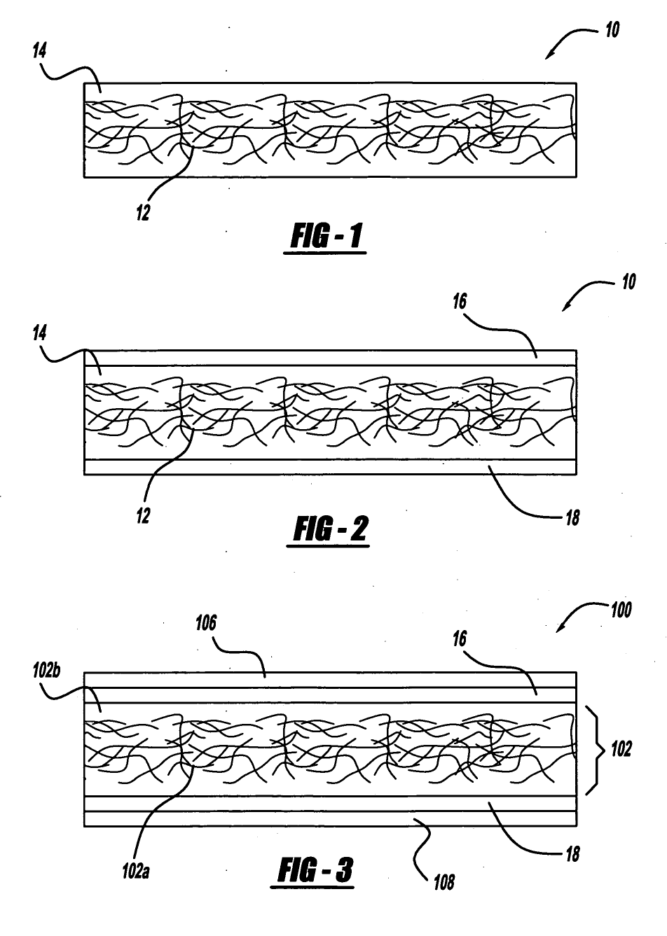

Referring to FIG. 1, there is shown a core component generally shown at 10. The core component 10 includes a natural fiber portion 12 and a binder portion 14. In accordance with one aspect of the present invention, the natural fiber portion 12 is comprised of a mat, a sheet-like format, or loose fibers. In accordance with one aspect of the present invention, the natural fiber portion 12 and the binder portion 14 are combined together, either partially or fully, so as to form a substantially homogenous material.

In accordance with one aspect of the present invention, the natural fibers suitable for use in the practice of the present invention can be separated into three broad categories: (1) bast fibers such as but not limited to hemp, flax, kenaf, ramie, jute, and/or the like; (2) leaf fibers such as but not limited to henequen, abaca, and/or the like; and (3) seed fibers such as but not limited to cotton and/or the like. However, it should be appreciated that any type of natural fiber can be used in the practice of the present invention.

Without being bound to a particular theory of the operation of the present invention, the bast and leaf fibers appear to offer the best properties in terms of the application described herein. In accordance with one aspect of the present invention, there is no particularly preferred form for these fibers as long as they have been refined to remove most or all of the impurities (e.g., such as the stems and/or the like) and they are at least one half inch in length. These natural fibers are readily commercially available from any number of suppliers and/or manufacturers.

In accordance with one aspect of the present invention, the polymeric binder can be comprised of materials such as but not limited to thermoplastic compounds, such as but not limited to polyolefins, e.g., polypropylene, e.g., in powder or sheet form. Liquid resins such as but not limited to aqueous acrylic resins or other thermoset materials (e.g., polyurethane, polyesters, epoxies, and/or the like) can be used as well.

Without being bound to a particular theory of the operation of the present invention, spraying liquid resins onto the fibers provides a better process to ensure a better dispersion. These polymeric binders are readily commercially available from any number of suppliers and/or manufacturers.

To produce the core component 10 of the present invention, the natural fibers first have to be dried out, e.g., in an oven, to reach proper level of dryness. Then the natural fibers are placed in a heated tool for the forming stage. For the forming process, the temperature ranges depend on the particular material used (e.g., thermoplastic and/or thermoset binders). The natural fibers are then mixed with the binder. For example, if liquid resin is used as a binder, small amounts are sprayed on the natural fiber mat. Alternatively, the thermoplastic binder can be used in powder or sheet form and can be arranged on the natural fiber mat. Depending on the thickness needed, multiple layers can be stacked alternatively following the same procedure. The two surfaces in contact with the tool's surfaces can also be provided with additional amounts of the binder to form impermeable layers, 16, 18, respectively, as specifically shown in FIG. 2. This operation prevents the resin from impregnating the core component 10 during the resin injection process.

The amount of binder and the molding pressure depend on the required density for the core component 10. The forming tool, which is heated to about 200° C., is then closed under pressure, e.g. for a few seconds or minutes, to give enough time for the binder to impregnate the natural fibers (i.e., the mat) and form a homogeneous material.

The material obtained can then be used as a core material in a composite structure 100, as specifically shown in FIG. 3. By way of a non-limiting example, after formation of the core component 102 (including a natural fiber portion 102a and a binder portion 102b), a reinforcing material (e.g., glass fibers, carbon fibers, aramid fibers and/or the like) can be placed on either side of the core component 102 and injected with a resin material 104. By way of a non-limiting example, the resin material 104 can be comprised of any number of polymeric materials, such as but not limited to thermoplastics, thermosets, and/or the like. Additionally, other optional layers, such as but not limited to impermeable binder layers 106, 108, respectively, can be provided to prevent infiltration of the resin material 104 into the core component 102.

Without being bound to a particular theory of the operation of the present invention, it is believed that improved skin-core adhesion (e.g., either chemically and/or physically) is achieved in the composite sandwich structure of the present invention, as compared to composite sandwich structures using conventional core materials.

It should be appreciated that the exact amounts and dimensions of materials used in conjunction with the present invention will depend, at least in part, on the size of the part, the required thickness of the core material, as well as its density.

In summary, the present invention provides, without limitation, the following advantages: (1) no foaming and/or curing time required in this structure; e.g., the binder and the fiber are combined together and placed in a hot tool for a short forming process; (2) the presence of reinforcing fibers in the core material result in higher mechanical properties; (3) the use of natural fibers that are cheaper than materials used in typical formable core structures, therefore for similar densities, the present invention will result in lower cost materials; (4) the presence of natural fibers and a recyclable binder results in a fully recyclable material; and (5) the presence of fibers and binders at the surface of the core enhances the core-skin adhesion by improving chemical and mechanical bonding with the resin injected in the skin.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A core component for use in connection with a composite structure, comprising:
a natural fiber portion; and
a polymeric binder portion substantially infiltrating said natural fiber portion.

2. The invention according to claim 1, wherein the natural fiber portion is a material selected from the group consisting of bast fibers, leaf fibers, seed fibers, and combinations thereof.

3. The invention according to claim 2, wherein the bast fibers is a material selected from the group consisting of hemp, flax, kenaf, ramie, jute, and combinations thereof.

4. The invention according to claim 2, wherein the leaf fibers is a material selected from the group consisting of henequen, abaca, and combinations thereof.

5. The invention according to claim 2, wherein the seed fibers is comprised of cotton seed fibers.

6. The invention according to claim 1, wherein the polymeric binder portion is comprised of a material selected from the group consisting of thermoplastics, thermosets, and combinations thereof.

7. The invention according to claim 1, wherein the polymeric binder portion is comprised of a material selected from the group consisting of polyolefins, polyurethanes, polyesters, epoxies, acrylics, and combinations thereof.

8. The invention according to claim 1, further comprising a skin layer adjacent to a surface of the core component.

9. The invention according to claim 1, further comprising a first skin layer adjacent to a first surface of the core component and a second skin layer adjacent to a second surface of the core component.

10. A composite structure, comprising:
a core component, comprising:
a natural fiber portion; and
a polymeric binder portion substantially infiltrating said natural fiber portion; and
a skin layer disposed on a surface of said core component.

11. The invention according to claim 10, wherein the natural fiber portion is a material selected from the group consisting of bast fibers, leaf fibers, seed fibers, and combinations thereof.

12. The invention according to claim 11, wherein the bast fibers is a material selected from the group consisting of hemp, flax, kenaf, ramie, jute, and combinations thereof.

13. The invention according to claim 11, wherein the leaf fibers is a material selected from the group consisting of henequen, abaca, and combinations thereof.

14. The invention according to claim 11, wherein the seed fibers is comprised of cotton seed fibers.

15. The invention according to claim 10, wherein the polymeric binder portion is comprised of a material selected from the group consisting of thermoplastics, thermosets, and combinations thereof.

16. The invention according to claim 10, wherein the polymeric binder portion is comprised of a material selected from the group consisting of polyolefins, polyurethanes, polyesters, epoxies, acrylics, and combinations thereof.

17. The invention according to claim 10, further comprising a second skin layer disposed on a second surface of the core component.

18. A method for forming a core component for use in connection with a composite structure, comprising:
providing a natural fiber portion, wherein the natural fiber portion is a material selected from the group consisting of bast fibers, leaf fibers, seed fibers, and combinations thereof, wherein the bast fibers is a material selected from the group consisting of hemp, flax, kenaf, ramie, jute, and combinations thereof, wherein the leaf fibers is a material selected from the group consisting of henequen, abaca, and combinations thereof, and wherein the seed fibers is comprised of cotton seed fibers;
providing a polymeric binder portion, wherein the polymeric binder portion is comprised of a material selected from the group consisting of polyolefins, polyurethanes, polyesters, epoxies, acrylics, and combinations thereof; and
substantially infiltrating said natural fiber portion with said polymeric binder portion.

19. The invention according to claim 18, further comprising providing a skin layer adjacent to a surface of the core component.

20. The invention according to claim 18, further comprising providing a first skin layer adjacent to a first surface of the core component and a second skin layer adjacent to a second surface of the core component.
